(19) United States
(12) Patent Application Publication
(10) Pub. No.: US 2026/0286015 A1
(43) Pub. Date: Sep. 24, 2026

(54) METHODS FOR THE SYNTHESIS OF POLYMERS AND POLYMERS OBTAINED THEREOF

(71) Applicant: SYNKOTECH BIOCOMPATIBLE MATERIALS, S.L., REUS (TARRAGONA) (ES)

(72) Inventors: Marina TORAL MILIAN, REUS (ES); Angélica BALANTA CASTILLO, REUS (ES); Verónica DE LA FUENTE MOLINA, REUS (ES); Amadeu BONET LAPLANA, REUS (ES)

(73) Assignee: SYNKOTECH BIOCOMPATIBLE MATERIALS, S.L., REUS (TARRAGONA) (ES)

(21) Appl. No.: 19/497,018

(22) PCT Filed: Apr. 24, 2024
(86) PCT No.: PCT/EP2024/061233

§ 371 Date: Dec. 24, 2025

(30) Foreign Application Priority Data
May 2, 2023 (EP) 23382408.5

(51) Int. Cl. C08F 2/06; C08F 4/16; C08F 6/02; C08F 18/14

(52) U.S. Cl. CPC C08F 2/06; C08F 4/16; C08F 6/02; C08F 18/14

(57) ABSTRACT

Methods for the synthesis of polymers from a monomeric and/o polymeric composition including an electron-deficient monomer having at least two electron-withdrawing groups, such as sprayable polymers and polymers for use in polymer-based formulations, are provided. The methods include steps for reacting, in a reaction vessel, a composition including a monomeric and/or polymeric composition including at least one monomer including at least two electron-withdrawing groups, where at least one of the electron-withdrawing groups is an ester, and a solvent in a relation monomeric and/or polymeric composition:solvent from 1:4 to 1:20 w/w; adding a microporous material at a temperature in the range of room temperature to solvent boiling temperature; and stirring until a conversion rate ≥98% is achieved.

### TECHNICAL FIELD

The present invention relates to methods for the synthesis of polymers from a monomeric and/o polymeric composition comprising an electron-deficient monomer having at least two electron-withdrawing groups, in particular sprayable polymers, polymer dissolution and polymers for use in polymer-based formulations. The methods of the invention involve specific reaction conditions to achieve high conversion rates and obtain high-quality polymers for diverse applications within the field of medical adhesives.

The present invention further relates to polymers obtained by such methods and polymer-based compositions.

### Background

Polymers obtained from the polymerization of a monomeric and/or polymeric composition comprising at least one electron-deficient monomer having at least two electron-withdrawing groups are a type of functional polymers that find applications in a wide range of fields, including coatings, adhesives, and other polymeric materials. These polymers possess unique properties, such as good thermal stability and excellent mechanical properties, making them suitable for diverse industrial applications.

Such polymers can be synthesized using various monomers, initiators, and polymerization methods, leading to different chemical structures and properties.

Conventional methods for the synthesis of polymers often suffer from issues such as low conversion rates, poor polymer properties, and difficulties in controlling the polymerization process. Therefore, there is a need for improved methods for the synthesis of polymers that overcomes these limitations and offer advantages in terms of efficiency, productivity, and product quality.

### SUMMARY

Specific reaction conditions (including among others monomer to solvent ratio, reaction temperature, reaction times, type of catalyst, type of solvent) have a significant impact on the properties of the resulting polymer, such as its molecular weight, Tg, thermal stability, and morphology. Optimization of these parameters is necessary to achieve the desired properties for the particular applications of the present invention.

Spray, sprayable polymers or solution polymers are types of polymers that can be applied in a spray form onto a surface. Methods for the synthesis of sprayable polymers from a monomeric and/or polymeric composition comprising an electron-deficient monomer having at least two electron-withdrawing groups, as disclosed in the present invention, offers several advantages over conventional methods, including:

High conversion rates: The use of a microporous material as a catalyst in the reaction process enables high conversion rates greater than 98%, resulting in improved efficiency and productivity.

Superior polymer properties: The resulting malonate polymers obtained by the methods of the present invention exhibit superior polymer properties, such as improved thermal stability, high reactivity, and excellent mechanical properties, making them suitable for diverse applications. Enhanced process control: The method allows for precise control of the polymerization process

The methods of the present invention provide improved reliability when compared to other methods for sprayable monomers that polymerize in contact with a relevant surface, and result in final solutions that can be directly applied without any further purification.

### BRIEF DESCRIPTION OF THE DRAWINGS

FIG. 1 shows vials containing polymers obtained by the methods of the present invention by means of different solvent percentages.

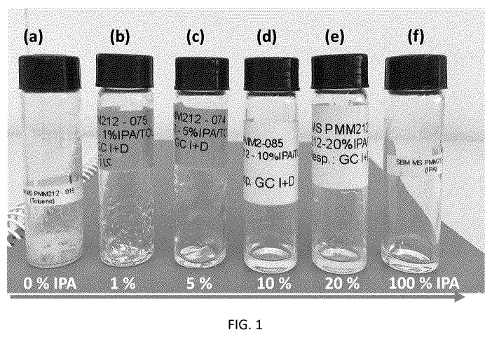

### DETAILED DESCRIPTION

The present invention provides a method for the synthesis of sprayable polymers or solution polymers from a monomeric and/or polymeric composition comprising at least an electron-deficient monomer having at least two electron-withdrawing groups, wherein at least one of said electron-withdrawing groups is an ester. The ester can be used directly for spraying or coating purposes. Said method involves several steps to achieve high conversion rates and superior polymer properties.

Examples of electron-deficient monomers having at least two electron-withdrawing groups, wherein at least one of said electron-withdrawing groups is an ester, are, but not limited to, malonate esters having the following general formula:

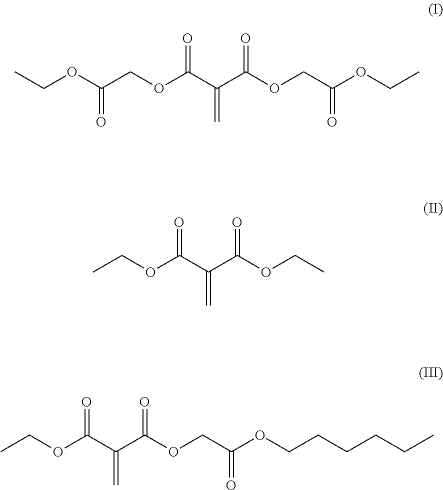

Malonate esters are organic compounds that contain a diester of malonic acid, which has the general structure R—CO-CH2-COOR′, where R and R′ are organic groups.

Carbonyl (C═O) groups, which are electron-withdrawing groups, exhibit a strong electron-withdrawing effect due to their electronegativity, which can impact the reactivity and properties of malonate esters.

In a first step, a monomeric and/or polymeric composition comprising an electron-deficient monomer having at least two electron-withdrawing groups, wherein at least one of said electron-withdrawing groups is an ester, and a solvent are reacted in a suitable reaction vessel.

The monomer to solvent ratio is maintained in the range of 1:4 to 1:20 w/w to ensure optimal reaction conditions.

The solvent may be selected from an organic non-alcoholic or an organic alcoholic solvent.

Further, the reaction mixture is stirred to promote uniform mixing and reaction of the monomer and solvent. A catalyst is then added to the reaction mixture in an amount of about 0.1% to 5% based on the total weight of the monomeric and/or polymeric composition at a temperature in the range room temperature to 50° C. The catalyst of the present method is in the form of a microporous material that acts by activating the monomer molecules, facilitating the formation of a reactive intermediate. Once activated, the reaction can continue without the presence of the microporous material.

In an embodiment of the present invention the microporous material is an aluminosilicate catalyst, which may be in binder form, wherein the aluminosilicate catalyst is heterogenous or powder.

The microporous material may be activated or regenerated prior to use.

The intermediate reacts with other monomers present in a monomeric and/or polymeric composition to form a polymer.

The reaction mixture is then stirred and allowed to react until a conversion rate ≥98% is achieved. The use of the microporous material aids in achieving a high conversion rate and enhances the polymerization process.

Once a conversion rate of ≥98% is achieved, the microporous material may be removed from the reaction mixture, for example, by filtration or other suitable means, such as centrifugation or if microporous material is in the form of beads (or compacted material), just removed from the reaction vessel.

If required, the solvent may then be evaporated, for example, under vacuum at a temperature of 60-80° C. to remove excess solvent and concentrate the polymer product.

The resulting sprayable polymer or polymer solution obtained by the method of the present invention exhibits high conversion rates, superior polymer properties, and improved performance characteristics for use in a spray applicator.

The present invention further provides a method for the synthesis of polymers for use in polymer-based formulations.

In a first step, a monomeric and/or polymeric composition comprising an electron-deficient monomer having at least two electron-withdrawing groups, wherein at least one of said electron-withdrawing groups is an ester, and a solvent mixture are reacted in a suitable reaction vessel. The monomeric and/or polymeric composition to solvent mixture ratio is maintained in the range of 1:4 to 1:20 w/w to ensure optimal reaction conditions.

The solvent mixture may be selected from a mixture of an organic non-alcoholic and organic alcoholic solvent.

Further, the reaction mixture is stirred to promote uniform mixing and reaction of the monomer and solvent. A catalyst is then added to the reaction mixture in an amount of about 1% to 20% based on the total weight of the monomer at a temperature in the range room temperature to 50° C. The catalyst of the present method is in the form of a microporous material that acts by activating the monomer molecules, facilitating the formation of a reactive intermediate. Once activated, the reaction can continue without the presence of the microporous material.

In an embodiment of the present invention the microporous material is an aluminosilicate catalyst in a binder form, wherein the aluminosilicate catalyst is heterogenous.

The microporous material may be activated or regenerated prior to use.

The intermediate reacts with other monomers present in a monomeric composition and/or polymeric composition to form a polymer.

The reaction mixture is then stirred and allowed to react until a conversion rate of ≥98% is achieved. The use of the microporous material aids in achieving a high conversion rate and enhances the polymerization process.

Once a conversion ration ≥98% is achieved, the microporous material is removed from the reaction mixture.

In an embodiment of the present invention, the microporous material is physically separated from the reaction mixture. Said physical separation may be provided, for example, by means of, for example a bag or net.

If required, the solvent may then be evaporated, for example, under vacuum at a temperature of 60-80° C. to remove excess solvent and concentrate the polymer product.

The resulting polymer obtained by the method of the present invention exhibits high conversion rates, superior polymer properties, and improved performance characteristics, such as lack of impurities, for use in a polymer-based formulations.

Table I shows viscosity values of the polymers of the present invention. Polymers, obtained from different solvent or solvent mixtures were diluted in a solvent at different solvent to polymer ratios and tested at 50% torque analysis with a C41 plate (25° C., 0.5 ml sample).

TABLE I

| Solvent | | Solvent:polymer ratio | | | | | |
|---|---|---|---|---|---|---|---|
| mixture | | 0.25:1 | 0.5:1 | 0.66:1 | 1:1 | 1.5:1 | 2:1 |
| (Tol:IPA) | State | Viscosity (cP) | | | | | |
| 96:4 | Gel | | | | | * | 296 |
| 94:6 | Gel | | | | * | 189 | 56.5 |
| 93:7 | | | * | 163 | 13.6 | 5.9 | |
| 92:8 | Liquid | * | 169.8 | 13.9 | 8.7 | 4.2 | |
| 90:10 | Liquid | 119 | 25 | | 6 | | |
| 0:100 | Liquid | 103 | 17 | | | | |

* Not possible to determine over limits of instrument

To such an effect, the method may further comprise mixing the resulting polymer with other polymers, in particular deactivated acrylates, and/or additives at a temperate of about 80° C. until fully integrated to generate a solid tacky adhesive and adding at least one stabilizer while mechanically stirring at a temperature of about 50° C. to obtain high content polymer formulation. The method may further comprise adding other cosolvents, active ingredients or additives.

Deactivated acrylates, as used herein, are acrylate monomers or polymers that have been chemically modified or treated to reduce their reactivity or functionality. Acrylates are a class of monomers that contain an acryloyl group (CH2=CH—CO—) and are widely used in the production of various polymers, coatings, adhesives, and other industrial applications.

The term “deactivated” refers to chemical modifications or treatments have been applied to the acrylate monomers or polymers to alter their properties. For example, deactivation may involve blocking or reducing the reactivity of the acrylate group, or modifying the functional groups attached to the acrylate moiety. This can be done to control the polymerization rate, improve stability, or modify the physical or chemical properties of the resulting polymers.

### Effect of Solvent to Composition Ratio

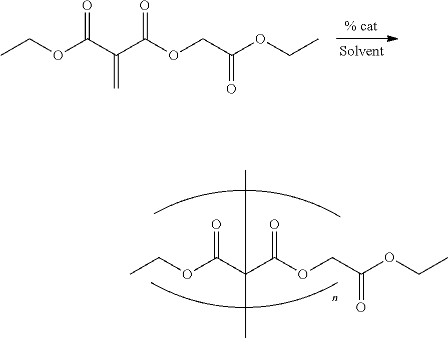

A composition comprising an electron-deficient monomer having at least two electron-withdrawing groups, wherein at least one of said electron-withdrawing groups is an ester, in particular a malonate monomer having general formula (I), and a solvent, in particular CHCl3, in different composition to solvent ratios, were added in a reaction vessel with a stir bar and let stir until fully homogenized. Once homogenized 1% of molecular sieves in the form of Type 4A powder were added to the reaction mixture at room temperature. The reaction mixture was let to react under stirring.

Table II shows the conversion rates (%) measured by NMR for different reaction times and different solvent to composition ratios.

TABLE II

| Solvent: | | | | | |
|---|---|---|---|---|---|
| Composition | Time (min) | | | | |
| (w/w) | 30 | 60 | 120 | 240 | > 240 |
| Neat | — | — | — | — | — |
| 1:1 | — | — | — | — | — |
| 1:2 | — | — | — | — | — |
| 1:4 | 71 | 78 | 85 | | 99 |
| 1:8 | 20 | 50 | 79 | 92 | 99 |
| 1:20 | 27 | 37 | 29 | | 99 |

### Effect of Reaction Temperature

Further, the same process conditions were carried out at different temperatures and a fixed solvent to composition ratio of 1:8 w/w.

Table III shows the conversion rates (%) measured by NMR for different reaction times and temperatures.

TABLE III

| | |
|---|---|
| Temperature | Time (min) |

| (° C.) | 30 | 60 | 120 | 240 | on | ow |
|---|---|---|---|---|---|---|
| 70 | — | — | — | — | 14 | 18 |
| 25 | 20 | 63 | 84 | 92 | 99 | |
| 50 | 62 | 84 | 90 | 92 | 99 | |

### Effect of Format and Amount of Catalyst

Additionally, the same process conditions were reproduced using Type4A molecular sieves in the form of beads instead of powder.

Table IV shows the conversion rates (%) measured by NMR for different reaction times and different solvent to composition ratios.

TABLE IV

| | Time (min) | | | | |
|---|---|---|---|---|---|
| Solvent: | 30 | 60 | 120 | 240 | > 240 |
| composition | Conversion rates | | | | |
| (w/w) | (%) | | | | |
| Neat | — | — | — | — | — |
| 1:1 | — | — | — | — | — |
| 1:2 | — | — | — | — | — |
| 1:4 | 21 | 35 | 45 | — | 99 |
| 1:8 | 10 | 25 | 35 | — | 99 |
| 1:20 | 9 | 17 | 28 | — | 99 |

For composition to solvent ratios of 1:1 and 1:2 gelification occurred at 10 minutes and 30 minutes, respectively, without complete conversion.

The effect of the amount (%) of catalyst, whether in the form of a powder or in the form of beads was also tested using two different solvents, in particular, toluene and IPA.

Table V shows the conversion rates (%) measured by NMR for different reaction times, i.e., 6 h and 16h, and different solvent to catalyst ratios.

TABLE V

| | MS | Conversion | MS | Conversion |
|---|---|---|---|---|
| | beads | rate | powder | rate |
| Solvent | (%) | at 16 h (%) | (%) | at 6 h (%) |
| Toluene | 5 | 6 | 0.1 | 60 |
| | 10 | 84 | 0.5 | 85 |
| | 20 | 97 | 1 | 99 |
| | 50 | 99 | 2.5 | 99 |
| | 100 | 99 | 5 | 99 |
| IPA | 5 | 78 | 0.1 | 45 |
| | 10 | 90 | 0.5 | 80 |
| | 20 | 95 | 1 | 99 |
| | 50 | 99 | 2.5 | 99 |
| | 100 | 99 | 5 | 99 |

TABLE VI

| Catalyst (1%) | Conversion rate after 4 h |
|---|---|
| Aluminosilicate (4A Molecular | 82% |
| sieves powder) | |
| Silica gel | 23% |
| 1% tertiary amine in Silica | 31% |
| Alumina | 19% |
| Charcoal | 11% |
| Celite | 27% |

### Molecular Sieves 4A

Composition: Sodium form of the synthetic zeolite (Na12[(AlO2)12(SiO2)12]·xH2O).

Pore Size: Approximately 4 angstroms (0.4 nm).

### Silica Gel

Composition: Amorphous form of silicon dioxide (SiO2).

Pore Size: Variable, ranging typically from 2 to 50 nm.

### Alumina

Composition: Aluminum oxide (Al2O3).

Pore Size: Typically, in the range of 8 to 10 nm for adsorption purposes.

### Celite

Composition: Diatomaceous earth, primarily consisting of the fossilized remains of diatoms (amorphous silica).

Pore Size: Relatively coarse, non-uniform pores.

### Charcoal (Activated Carbon)

Composition: Carbon obtained from charred materials like wood, coal, coconut shells. Pore Size: Highly porous with a wide range of pore sizes.

As an aluminosilicate, 4A Molecular Sieves offer a better performance in terms of reactivity than all the other elements, including amine dopped silica. Preferably, the method of the invention uses aluminosilicates, more preferably being 4A Molecular Sieves. Other molecular sieve sizes (3A, 4A, 5A, 10×) having a slightly modified chemical composition and channel size may also be used.

### Effect of the Type of Solvent/Solvent Mixture

Additionally, different types of solvents or solvent mixtures were tested at a composition to solvent ratio of 1:8 w/w in a container with a stir bar and let stir until fully homogenized. 1% of molecular sieves in the form of powder Type 4A or 20% of molecular sieves in the form of Type 4A beads were added, indistinctively, to the reaction mixture at room temperature. Moderate stirring was then performed and the reaction mixture was let to react.

Table VII shows the conversion rates (%) measured by NMR for different reaction times and different types of solvents:

TABLE VII

| | Solvent/Solvent | Time (min) | | |
|---|---|---|---|---|
| Solvent:Composition | mixture | 60 | 120 | >120 |
| 1:8-1:10 | CHCl₃ | 66 | 85 | 99 |
| 1:8-1:10 | DMSO | 99 | 99 | 99 |
| 1:8-1:10 | THF | 99 | 99 | 99 |
| 1:6-1:20 | Toluene | 99 | 99 | 99 |
| 1:8-1:10 | EtOAc | 99 | 99 | 99 |
| 1:6-1:20 | IPA | 92 | 99 | 99 |
| 1:8-1:10 | EtOH | 99 | 99 | 99 |
| 1:8-1:10 | Hexanol | 99 | 99 | 99 |
| 1:8-1:10 | Dioxane | 99 | 99 | 99 |
| 1:8-1:10 | Acetone | 99 | 99 | 99 |
| 1:8-1:10 | Toluene:IPA 99:1 | 99 | 99 | 99 |
| 1:8-1:10 | Toluene:IPA 99:2 | 99 | 99 | 99 |
| 1:8-1:10 | Toluene:IPA 99:5 | 99 | 99 | 99 |
| 1:8-1:10 | Toluene:IPA 99:7 | 99 | 99 | 99 |
| 1:8-1:10 | Toluene:IPA 9:1 | 99 | 99 | 99 |
| 1:8-1:10 | Toluene:IPA 8:2 | 99 | 99 | 99 |

1-16. (canceled)

17. A method of synthesizing sprayable polymers, the method comprising steps of:
a. Reacting, in a reaction vessel, a composition comprising a monomeric and/or polymeric composition comprising at least one monomer comprising at least two electron-withdrawing groups, wherein at least one of said electron-withdrawing groups is an ester, and a solvent in a relation monomeric and/or polymeric composition:solvent from 1:4 to 1:20 w/w;
b. adding a microporous material in an amount of about 0.1%-5% based on the total weight of the monomer at a temperature in the range of room temperature to solvent boiling temperature; and
c. stirring until a conversion rate ≥98% measured by NMR is achieved.

18. The method according to claim 17, further comprising evaporating the solvent.

19. The method according to claim 17, further comprising removing the microporous material.

20. The method according to claim 17, wherein the solvent is an organic non-alcoholic or an organic alcoholic solvent.

21. The method according to claim 17, wherein the microporous material is an aluminosilicate catalyst.

22. The method according to claim 21, wherein the aluminosilicate catalyst is heterogenous or powder.

23. The method according to claim 22, wherein the catalyst is either not activated, activated or regenerated prior to use.

24. A sprayable polymer directly obtained by the method of claim 17.

25. A method for the synthesis of polymers for use in polymer-based formulations, the method comprising steps of:
a. reacting, in a reaction vessel, a monomeric and/or polymeric composition comprising at least one monomer comprising at least two electron-withdrawing groups, wherein at least one of said electron-withdrawing groups is an ester, and a solvent mixture in a relation monomeric and/or polymeric composition:solvent mixture of 1:4 to 1:20 w/w;
b. adding a microporous material in an amount of about 1-20% based on the total weight of the monomer at a temperature in the range of room temperature to solvent boiling temperature;
c. stirring until a conversion rate ≥98% is achieved; and
d. removing the microporous material.

26. The method according to claim 25, further comprising evaporating the solvent.

27. The method according to claim 25, wherein the solvent mixture comprises an organic non-alcoholic solvent or an organic alcoholic solvent and water.

28. The method according to claim 25, wherein the microporous material is an aluminosilicate catalyst.

29. The method according to claim 28, wherein the aluminosilicate catalyst is heterogenous.

30. A malonate polymer directly obtained by the method of claim 25.

31. The method according to claim 21, further comprising:
e. mixing the resulting polymer with other polymers or polymer solution and/or additives at a temperate range from room temperature to 100° C. until fully integrated and after removing the solvent generates a solid tacky adhesive; and
f. adding at least one stabilizer while mechanically stirring at a temperature of about 50° C. to obtain a 50/50 relation

32. A polymer composition directly obtained by the method of claim 31.
